(19) United States
(12) Patent Application Publication
(10) Pub. No.: US 2004/0196046 A1
(43) Pub. Date: Oct. 7, 2004

(54) Downhole measurement of rock properties

(76) Inventors: John William Aidan, Marlborough (GB); Richard Hedley Clarke, Marlborough (GB)

Correspondence Address: Ronald B Sherer, Bartlett & Sherer, 103 South Shaffer Drive, New Freedom, PA, 17349, US

(21) Appl. No.: 10/482,760

(22) PCT Filed: Jun. 28, 2002
(86) PCT No.: PCT/GB02/02997

(30) Foreign Application Priority Data
Jun. 28, 2001 (GB) 0115809.6

(51) Int. Cl. G01V 3/18; G01V 3/00

(52) U.S. Cl. 324/339; 324/334; 367/25; 324/347

(57) ABSTRACT

A method and apparatus for measuring properties of rocks surrounding a borehole comprises a means for generating an electromagnetic signal downhole and detecting the seismic signal generated thereby.

The present invention relates to apparatus and a method for measuring the properties of rocks such as permeability and fluid properties around a borehole.

The measurement of permeability of rocks surrounding a borehole is important in assessing the location of water or oil reserves, including the quality and quantity of the reservoir rock. Existing methods are unable to measure the permeability of a porous rock directly with any accuracy from a downhole tool. It is valuable to measure the properties of a formation during drilling in order to vary the drilling as a response (called geosteering).

In addition to its value in the assessment of the quality and quantity of porous rock containing water or oil in reservoirs, the rock permeability is very important in determining at what rate and at what cost these fluids can be produced from production wells.

U.S. Pat. No. 3,599,085 describes a method in which a sonic source is lowered down a borehole and used to emit low frequency sound waves. Electrokinetic effects in the surrounding fluid-bearing rock cause an oscillating electric field in this and is measured at least two locations close to the source by contact pads touching the borehole wall. The electromagnetic skin depth is calculated from the ratio of electrical potentials and the permeability of the rock deduced. U.S. Pat. No. 4,427,944 and the equivalent European Patent 0043768 describe a method which injects fluid at high pressure from a downhole tool to generate electrokinetic potentials; these are measured by contact electrodes against the borehole wall. The risetime of the electrical response is measured and from this the permeability of the porous rock is determined.

UK Patent 2,226,886A and the equivalent U.S. Pat. No. 4,904,942 describe several arrangements for recording electrokinetic signals from subsurface rocks mainly with the electrodes for measuring the signals at or close to the earth's surface but including use of an acoustic source mounted on a downhole tool. There is no indication of permeability being deduced or of inferring porosity. A further related (inverse) method is described in European Patent 0512756A1, which contains several arrangements for setting out electrical sources and acoustic receivers (geophones) in order to measure electro-osmotic signals induced in subsurface rocks.

PCT Patent application WO 94/28441 describes a method whereby sound waves of fixed frequency are emitted from a downhole source and the resulting electrokinetic potentials measured. An electrical source of fixed frequency is then used to produce electro-osmotic signals and the acoustic response measured. Using both responses together, the permeability is then deduced, provided the electrical conductivity of the rock is also separately measured.

In these methods the seismic shock is generated downhole at intervals and require a separate means for generating the signals downhole.

PCT Patent application PCT/GB 96/02542 discloses apparatus which comprises a module adapted to be lowered down a bore hole in which there is a means adapted to detect electrical signals generated by seismic signals emitted from the module in which the seismic signals are generated substantially radially from a source which is not in contact with the borehole wall.

It has been known for many years that a centralised (or under special circumstances deliberately off-centred) non-contact sonic tool may be used to generate seismic signals in a borehole and surrounding rock, and acoustic detectors used to monitor the returning signals. Typically the tool is centred in the borehole, and centralisers typically using bow springs or calliper arms used to maintain its central position. The tool itself is therefore not in direct contact with the borehole wall except via the centraliser. A range of source types (monopole or dipole for example) have been developed, used alone or in arrays to achieve focussed emitted acoustic signals. Tools with several sources and receivers are now conventional and provide well-controlled sonic emission and detection of sonic signals into and from the borehole wall and surrounding rock. Such measurements indicate variations in the acoustic velocity in the rock which relates to its porosity, but gives little indication of variation in permeability.

In addition resistivity tools have been used for many years. These may be centralised non-contact tools or use a contact pad to contact electrodes to the borehole wall, and apply a current to the surrounding rock. Measurement of the electric potential provides a measurement of the resistivity or conductivity of surrounding rock. Typically the tool is not in contact with the borehole walls and maintained in its central position by centralisers typically using bow springs or calliper arms. More recently it has become conventional alternatively to use a non-contact centralised tool which has an induction coil to generate the current in the formation rock. This uses one or more induction coil sources with their axis aligned along the borehole which generate currents in so-called conducting ground loops the surrounding rock, whose current is then monitored via their associated magnetic field by one or more receiver coils with similar alignment further along the tool. Use of multiple transmission electrodes or coils allows focussing of the source, and a better-controlled measurement of resistivity. The use of the induction coil also allows the measurement to be made when the drilling fluid is non-conducting, when there would be problems with non-contacting electrodes applying the electric current. The measurement of resistivity is useful in determining fluid properties, but provides little indication of the variation of permeability of the surrounding rock.

In U.S. Pat. No. 5,503,001 (Wong) sought to provide a method of measuring the permeability using an apparatus in contact with the borehole wall. The invention applied an electric potential at one or more frequencies via electrodes in the tool pad contacting the surrounding rock, and measures the pressure response induced as a result of the electroosmotic effect. The response is measured a small distance away from the location of the electric potential source. The electroseismic response may also separately be measured by this invention a short time later. This is done by a pressure source in a tool pad in contact with the borehole wall, generating pressure signals in the rock. These stimulate an electrical signal as a result of the electroseismic effect. This is detected by electrodes in the tool, which is in contact with the borehole wall. By measuring either the electroosmotic response alone, or in combination with the electroseismic response, this invention infers the permeability of the surrounding rock. However, this invention is difficult to use in practise because it is impractical to maintain uniform resistance connections between electrodes in a tool pad and the borehole wall when the pad is in contact with the borehole wall. It is also difficult to maintain a uniform pressure seal when a pressure source is within the same pad made to contact the wall. As both requirements must be met simultaneously for the measurement of the electroosmotic response to be accurate the invention is very difficult to use in practice.

In U.S. Pat. No. 5,877,995 (Thompson and Gist) also discusses making electroosmotic measurements downhole. These do not involve a logging sonde but are static measurements. They mention DC or AC measurements using an electric field source which may employ pulses or continuous frequencies. A seismic detector is used to monitor the electroosmotic response. The invention described has electrodes which contact the borehole wall downhole, and the detectors are pressure detectors which are also shown to contact the borehole wall. It therefore shares the practical problems of U.S. Pat. No. 5,503,001 should it be attempted to raise or lower the device and make continuous logging measurements, as the contact resistances of the electrodes and the pressure seals of the pressure sensors will vary as the device moves.

We have now devised an improved method for measuring properties of rock surrounding a borehole from a tool located down a borehole.

According to the invention there is provided a method of measuring the properties of rocks surrounding a borehole which method comprises generating an electromagnetic signal from at least one location downhole within the borehole and propagating the signal into the surrounding rock, detecting the seismic signals generated in the surrounding rock by the electromagnetic signal, receiving and processing these seismic signals by at least one detection means downhole.

The invention also provides apparatus for measuring the properties of rock surrounding a borehole which apparatus comprises a module adapted to be lowered down a borehole in which module there is a generating means able to generate an electromagnetic signal which is emitted into the rock surrounding the borehole and a detection means adapted to detect seismic signals generated in the surrounding rocks by the electromagnetic signal emitted from the module.

The seismic signals can be received and processed by the detection means to convert them to electric signals which can be sent to the surface for processing in order to obtain data concerning the properties of the surrounding rocks.

Properties which can be measured by the present invention include permeability and fluid properties.

To give an improved indication of the spatial distribution of electromagnetic signals emitted into the surrounding rock the electromagnetic signals emitted can be monitored and recorded by using at least one electromagnetic detector preferably placed at locations vertically displaced from the electromagnetic source.

Preferably, in use, the generating means is not in contact with the borehole wall but positioned within the tool either substantially centrally within the borehole or close to, but offset from, the borehole wall.

The generating means can be any means which can generate an electromagnetic signal. Suitable means include an induction coil and this can be positioned substantially centrally with its axis aligned horizontally; alternatively it may be offset from the centre and its axis alignment either horizontal or vertical to alter the distribution of magnetic field it generates within the surrounding rock.

Another generating means comprises an electrode pair used with the electrodes on the exterior of the tool body, which is substantially central within the borehole and the electrodes are not in contact with the borehole wall. Alternatively the electrodes may be made to contact the borehole wall e.g. by extension arms from the tool to the wall, or using a pad containing the electrode pair extended from the tool to make contact with the borehole wall.

In an embodiment of the method of invention in order to provide an improved measurement of rock properties, the method also includes generating a seismic signal downhole in sequence with the electromagnetic signal, propagating the seismic signal into the rock surrounding the borehole and detecting the electromagnetic signals generated in the surrounding rock by the seismic signal.

In an embodiment of the apparatus of the invention the module includes a seismic source able to generate a seismic signal and propagate it into the surrounding rock and an electromagnetic detection means able to detect the electromagnetic signal generated in the surrounding rock by the signal generated by the seismic source.

The seismic signals emitted by the seismic source may optionally be monitored and recorded by using, at least one pressure detector placed at locations vertically displaced from the electromagnetic source.

The electromagnetic signal is propagated by the generating means, which is referred to also as electromagnetic source, outwards from the generating means through the borehole fluid and subject to distortions by the borehole wall and variations in the rock out into the surrounding rock. In the case of an induction coil the electromagnetic source produces an oscillating magnetic field approximately symmetric about the axis of the coil. Electrodynamic theory indicates that an induced electrical field and current is produced around a loop within the surrounding rock also approximately aligned with the induction coil. This electrical field distribution at the borehole wall and within the surrounding rock generates an electroosmotic response in which a pressure wave response occurs.

In the case of the electrode pair, an electrical potential difference between them similarly produces an electrical field distribution in the borehole fluid and surrounding rock. Depending on the electrical conductivity of the borehole fluid this may produce a sufficient electrical field in the surrounding rock. Alternatively the electrodes can be made to contact the borehole wall to remove the effects of the borehole fluid, so that the electrical field distribution is less affected by the drilling fluid and predominantly determined by the contact resistances and the distribution of properties within the surrounding rock.

The frequency range in which the electromagnetic source is operated is preferably in the range 0.01 Hz to 100 Hz.

The pressure signal is produced in the surrounding rock by the applied electromagnetic signal as a result of the electroosmotic effect. The detection means are detectors which consist preferably of transducers, or hydrophones or geophones or similar such sensitive pressure measurement devices. The pressure detectors are preferably arranged along the body of the apparatus at various offset distances from the electromagnetic source.

The pressure signals are preferably converted to electrical signals by the detector, and can then be amplified and recorded for processing. Preferably the pressure signal response is compared with the electromagnetic source signal in order to give a measurement of the electroosmotic response coefficient K for the surrounding rock in proximity to the source and detector. If the electromagnetic source produces signals at one or more frequencies then the pressure signal response can be measured with reference to these source frequencies (for example by using a demultiplexer to compare them). In this way the amplitude and phase of the electroosmotic response K can be measured at each frequency.

If a more detailed set of measurements of the variation of pressure response with offset distance from the electromagnetic source is made, the pressure distribution in the surrounding rock can be inferred and compared with the distribution of the electromagnetic signals generating them in the surrounding rock. To facilitate this, one or more receiver induction coils or magnetometers may be use at varying offset distance from the electromagnetic source making a measurement of magnetic field distribution stimulated within the surrounding rock by the source.

In addition to the above measurement of pressure response signal and hence electroosmotic response coefficient K, there is the option of also measuring the electromagnetic response to a pressure signal, and hence electroseismic response coefficient C. Preferably the two measurements are made in an alternating manner, so that for any given piece of surrounding rock a measurement of each is made in rapid succession. The apparatus for the measurement of the electromagnetic response to a pressure signal lies vertically displaced along the tool and the time interval between the measurement of pressure response signal and electromagnetic response signal can be set according to the logging speed of vertical movement such that both measurements are made opposite the same vertical location in the borehole.

The optional second measurement is made by a seismic source or array of sources emitting a pressure signal from the apparatus of the invention. The seismic or acoustic source may consist of a transducer, magnetostrictive device, piezoelectric device, hydrophone, electromagnetic solenoid, adapter loudspeaker, mechanical device, sparker source, airgun or any such similar pressure wave generating device. The seismic source is preferably not in contact with the borehole wall but positioned within or on the module. The seismic signal is propagated outwards through the drilling fluid and subject to distortion by the borehole wall and variations in the rock the seismic signal propagates into the surrounding rock. An electromagnetic response signal is generated in the surrounding rock and is received and detected at the tool within the borehole.

The electromagnetic signals can be detected by means of one or more pairs of electrodes, or using other types of electric or magnetic field detector. These include a dipole pair antenna, an induction coil magnetometer, loop antenna, ferromagnetic-core loop antenna, dielectric disk antenna, magnetometer, optically pumped magnetometer, flux gate magnetometer, SQUID magnetometer or other similar device for measuring the electric or magnetic field. Preferably the electromagnetic signals are detected by means of an electrode pair positioned within the borehole close on the exterior of the body of the invention, close to but displaced vertically from the seismic source. The electrodes are preferably not in contact with the borehole wall, but may alternatively contact the wall by use of extension arms or an extending pad containing the electrodes, which extends out to contact the wall.

The seismic source or array or sources preferably emits sound as a series of pulses or on one or more frequencies as continuous oscillations. Several frequencies may typically be used, preferably in the frequency range from 10 to 10000 Hz. Preferably the electromagnetic signal is compared with the seismic source signal to infer the electroseismic response coefficient at each frequency. This may be done by demodulating the electromagnetic signal with respect to the seismic source signal, to give the amplitude and phase of the response at each frequency.

The electroseismic response coefficient C as a function of frequency may be used in inferring the properties of the surrounding rocks.

At low frequency the permeability k of the surrounding rock is believed to be closely related to the ratio of the electroosmotic coefficient K and the electroseismic coefficient C, obeying the following relationship:

k=ησK/C

where η is the fluid viscosity and σ the rock electrical conductivity.

In addition the electroosmotic coefficient K varies with frequency in a manner which gives an indication of permeability. By measuring K at various frequencies the critical frequency can be inferred, as the K is believed to vary as

K=−A exp(−iφ)

where A is the amplitude varying with frequency ω according to

A=K₀/√(1+ω²τ²)

and where K₀ is the low frequency value of K and φ the phase varying according to

Φ=arctan (ωτ)

The value of τ and hence the critical frequency f may therefore be inferred from measurements of the amplitude and phase of K at one or more frequencies.

It is believed that the permeability k is closely related to the critical frequency and approximately directly proportional to it:

k=Bf

where B is a constant which may be measured. By deriving the critical frequency of the electroosmotic response the permeability may subsequently be inferred using calibration values of B.

The permeability may be measured by the invention as a result of either measurement of the electroosmotic response alone, at one or more frequencies, or preferably an optional measurement of the electroseismic response at one or more frequencies as well. Comparison of the two measurements then gives an improved indication of the permeability.

The measurements can be made whilst the apparatus is lowered or raised up the borehole, after drilling has taken place, or during the drilling of the borehole. This provides a continuous or semi-continuous set of measurements of the surrounding rock along the borehole, or log. The information may be used to guide the drilling of the hole, or decisions on how best to develop the hole once drilled.

The invention is illustrated in the accompanying drawings in which:

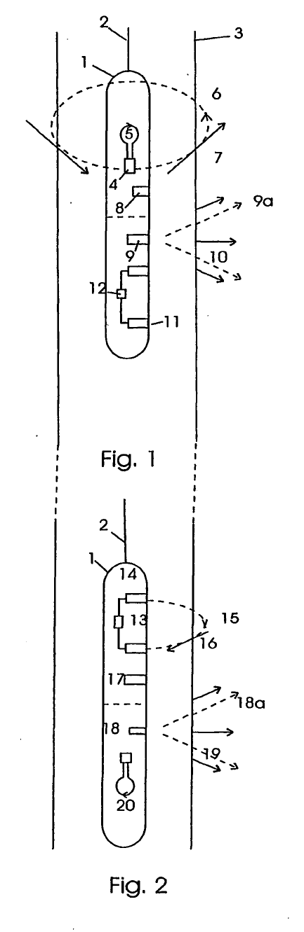

FIG. 1 shows an embodiment of the invention in which the electromagnetic source is an induction coil and

FIG. 2 shows another embodiment of the invention in which the electromagnetic source is an electrode pair.

Referring to FIG. 1 a module which comprises a downhole tool (1) is connected by a cable (2) to the surface so that it can be raised or lowered along the borehole (3). Electrical circuits making up an electromagnetic source driver drive an induction coil (4), which is the electromagnetic source. There is a pressure detector (8) which can detect pressure changes generated in the rock surrounding borehole (3). Both the source driver (4) and detector (8) are connected to monitoring electronics, where the measurement data is received and sent up the cable to the surface via the cable (2).

There is a seismic or sonic source (9) which can generate a pressure signal (9a) an electromagnetic detector, consisting of an electrode pair (11), attached to a sensitive receiver (12) which can detect an electromagnetic signal generated in the rock surrounding borehole (3).

In use a current in the induction coil generates an induced magnetic field within the surrounding rock, which in turn causes an induced current to flow within the surrounding rock. This current, flowing in rock of limited electrical conductivity, has an associated electrical field, and a pressure response (7) produced due to the electroosmotic effect. The result is a pressure oscillation of the surrounding rock and borehole walls which is detected by pressure detector (8) and converted into an electrical signal and amplified by electronic circuits and sent the surface via cable (2).

The seismic or sonic source (9) generates a pressure signal (9a) which travels through the borehole fluid into the surrounding rock. An electric field (10) is generated within the surrounding rock as a result of the electroseismic effect. This electric field is detected by an electromagnetic detector, consisting of an electrode pair (11), attached to a sensitive receiver (12). This amplifies the electric field signal, and both the seismic source (9) and receiver (12) are connected to the monitoring electronics, which receives and sends data to the surface via the cable (2).

Referring to FIG. 2, the electromagnetic source driver (13) is connected to an electrode pair (14) which generates an electromagnetic signal. Pressure detector (17) can monitor pressure generated in the rock surrounding borehole (3). Both source driver (13) and detector (17) are connected to monitoring electronics where measurement data is received and sent up to the surface via the cable (2). There is a seismic or sonic source (18) which can generate a seismic signal (18a) and an electromagnetic detector, consisting of an induction coil (20), attached to a sensitive receiver (21) which can amplify the electric field signal generated, both the seismic source (19) and receiver (21) are connected to the monitoring electronics, which can receive and send data to the surface via the cable (2).

In use there is an electric potential between the electrode pair (14) which generates an electric field (15) within the surrounding rock. A pressure response (16) is produced in the rock and borehole wall due to the electroosmotic effect. The effect is monitored by the pressure detector (17). Both source driver (13) and detector (17) are connected to monitoring electronics where measurement data is received and sent up to the surface via the cable 2.

The seismic or sonic source (18) generates a pressure signal (18a) which travels through the borehole fluid into the surrounding rock. An electric field (19) is generated within the surrounding rock as a result of the electroseismic effect. This electric field is detected by an electromagnetic detector, consisting of an induction coil (20), attached to a sensitive receiver (21). This amplifies the electric field signal, and both the seismic source (19) and receiver (21) are connected to the monitoring electronics, which receives and sends data to the surface via the cable (2).

1. A method of measuring the properties of rocks surrounding a borehole which method comprises generating an electromagnetic signal by a generating means downhole within the borehole, propagating the signal into the surrounding rock and detecting the seismic signals generated in the surrounding rock by the electromagnetic signal by at least one seismic detection means downhole.

2. A method as claimed in claim 1 in which seismic signals are received and processed by the seismic detection means to convert them to electric signals.

3. A method as claimed in claim 1 or 2 in which the electromagnetic signals emitted into the surrounding rock are monitored and recorded by using at least one electromagnetic detector placed at location(s) vertically displaced from the electromagnetic source.

4. A method as claimed in claim any one of the preceding claims in which the generating means is not in contact with the borehole wall but positioned either substantially centrally within the borehole or close to, but offset from, the borehole wall.

5. A method as claimed in claim any one of the preceding claims in which the generating means is an induction coil which is positioned substantially centrally with its axis aligned horizontally and a current in the induction coil generates an induced magnetic field within the surrounding rock, which in turn causes an induced current to flow within the surrounding rock which is detected by an induced current detection means

6. A method as claimed in claim any one of the preceding claims in which the generating means is an induction coil which is positioned offset from the centre off the borehole and its axis alignment either horizontal or vertical to alter the distribution of magnetic field it generates within the surrounding rock and a current in the induction coil generates an induced magnetic field within the surrounding rock, which in turn causes an induced current to flow within the surrounding rock which is detected by induced current detection means

7. A method as claimed in claim any one of the preceding claims in which the generating means comprises an electrode pair with the electrodes positioned substantially central within the borehole and the electrodes are not in contact with the borehole wall and there is an electric potential between the electrode pair which generates an electric field within the surrounding rock which causes an induced current to flow within the surrounding rock which is detected by an induced current detection means.

8. A method as claimed in claim any one of the preceding claims in which the generating means comprises an electrode pair with the electrodes in contact the borehole wall and there is an electric potential between the electrode pair which generates an electric field within the surrounding rock which causes an induced current to flow within the surrounding rock which is detected by the detection means

9. A method as claimed in claim any one of the preceding claims in which the generating means has a frequency in the range 0.01 Hz to 100 Hz.

10. A method as claimed in claim any one of the preceding claims in which the seismic detection means are pressure detectors selected from transducers, hydrophones geophones and similar such sensitive pressure measurement devices.

11. A method as claimed in claim 10 in which the pressure detectors are arranged along the body of the apparatus at various offset distances from the electromagnetic source.

12. A method as claimed in claim any one of the preceding claims in which the seismic signals are pressure signals which are converted to electrical signals by the detector, and transmitted to the surface.

13. A method as claimed in any one of the preceding claims in which the seismic signal is compared with the electromagnetic source signal to give a measurement of the electroosmotic response coefficient K for the surrounding rock in proximity to the source and detector.

14. A method as claimed in claim 13 in which the electromagnetic source produces signals at one or more frequencies and the pressure signal response is measured with reference to these source frequencies to obtain the amplitude and phase of the electroosmotic response K measured at each frequency.

15. A method as claimed in claim 13 or 14 in which a set of measurements of the variation of pressure response with offset distance from the electromagnetic source is made, the pressure distribution in the surrounding rock inferred and compared with the distribution of the electromagnetic signals generating them in the surrounding rock by means of making a measurement of magnetic field distribution stimulated within the surrounding rock by the source using at least one receiver induction coil or magnetometer at varying offset distance from the electromagnetic source.

16. A method as claimed in any one of the preceding claims which comprises generating a seismic signal from a seismic source downhole in sequence with the electromagnetic signal, propagating the seismic signal into the rock surrounding the borehole and detecting the electromagnetic signals generated in the surrounding rock by the seismic signal.

17. A method as claimed in claim 16 in which the seismic signals emitted by the seismic source are monitored and recorded by using at least one pressure detector placed at locations vertically displaced from the electromagnetic source.

18. A method as claimed in claim 16 or 17 in which the generating means and the seismic detection means are mounted on a tool and measurements are made whilst the tool is moving vertically in the borehole and the time interval between the measurement of pressure response signal and electromagnetic response signal is set according to the speed of vertical movement such that both measurements are made opposite the same vertical location in the borehole.

19. A method as claimed in any one of claims 16 to 18 in which the seismic signal is generated by a seismic source or array of sources emitting a pressure signal which seismic source is a transducer, magnetostrictive device, piezoelectric device, hydrophone, electromagnetic solenoid, adapter loudspeaker, mechanical device, sparker source, airgun or any such similar pressure wave generating device.

20. A method as claimed in any one of claims 16 to 19 in which the seismic source is not in contact with the borehole wall but positioned within or on the module.

21. A method as claimed in any one of claims 16 to 20 in which the electromagnetic signals are detected by means of one or more pairs of electrodes, or other type of electric or magnetic field detector.

22. A method as claimed in any one of claims 16 to 20 in which the electromagnetic signals are detected by means of a dipole pair antenna, an induction coil magnetometer, loop antenna, ferromagnetic-core loop antenna, dielectric disk antenna, magnetometer, optically pumped magnetometer, flux gate magnetometer or SQUID magnetometer.

23. A method as claimed in any one of claims 16 to 22 in which the seismic source or array of sources emits sound as a series of pulses or on one or more frequencies as continuous oscillations.

24. A method as claimed in claim 23 in which the frequencies used are in the frequency range from 10 to 10000 Hz.

25. A method as claimed in any one of claims 23 or 24 in which the electromagnetic signal is compared with the seismic source signal to infer the electroseismic response coefficient at each frequency.

26. A method as claimed in any one of the preceding claims in which the properties of the rocks are measured during vertical displacement of the generating means within the borehole.

27. Apparatus for measuring the properties of rock surrounding a borehole which apparatus comprises a module adapted to be lowered down a borehole in which module there is a generating means able to generate an electromagnetic signal which is emitted into the rock surrounding the borehole and a detection means adapted to detect seismic signals generated in the surrounding rocks by the electromagnetic signal emitted from the module.

28. Apparatus as claimed in claim 27 in which there are means for processing the signals detected by the detecting means to convert them to electric signals.

29. Apparatus as claimed in claim 27 or 28 in which there is at least one electromagnetic detector placed at locations vertically displaced from the electromagnetic source

30. Apparatus as claimed in claim any one of claims 27 to 29 in which there are means to position the seismic source within the tool either substantially centrally within the borehole or close to, but offset from, the borehole wall

31. Apparatus as claimed in claim any one of claims 27 to 30 in which the generating means is an induction coil.

32. Apparatus as claimed in claim any one of claims 27 to 30 in which the generating means comprises an electrode pair.

33. Apparatus as claimed in claim any one of claims 27 to 32 in which the detection means are pressure detectors selected from transducers, hydrophones, geophones or similar such sensitive pressure measurement devices

34. Apparatus as claimed in claim 33 in which the pressure detectors are arranged along the body of the apparatus at various offset distances from the electromagnetic source.

35. Apparatus as claimed in claim any one of claims 27 to 34 in which there is a seismic generating means for generating a seismic signal downhole in sequence with the electromagnetic signal, and an electromagnetic detecting means for detecting the electromagnetic signals generated in the surrounding rock by the seismic signal.

36. Apparatus as claimed in claim 33 in which there is at least one pressure detector placed at locations vertically displaced from the electromagnetic source to monitor and record the seismic signals emitted by the seismic source.

37. Apparatus as claimed in any one of claims 35 to 36 in which in which the seismic generating means is a seismic source or array of sources emitting a pressure signal which seismic source is a transducer, magnetostrictive device, piezoelectric device, hydrophone, electromagnetic solenoid, adapter loudspeaker, mechanical device, sparker source, airgun or any such similar pressure wave generating device.

38. Apparatus as claimed in any one of claims 35 to 37 in which the electromagnetic detection means is one or more pairs of electrodes, or other type of electric or magnetic field detector.

39. Apparatus as claimed in any one of claims 35 to 37 in which the electromagnetic detection means is a dipole pair antenna, an induction coil magnetometer, loop antenna, ferromagnetic-core loop antenna, dielectric disk antenna, magnetometer, optically pumped magnetometer, flux gate magnetometer or SQUID magnetometer.
